(19) United States
(12) Patent Application Publication
(10) Pub. No.: US 2007/0111920 A1
(43) Pub. Date: May 17, 2007

(54) Method for production of solid granulated with improved storage stability and abrasion resistance

(76) Inventors: Dieter Baur, Dusseldorf (DE); Lars Kucka, Essen (DE); Wilfried Rahse, Dusseldorf (DE)

Correspondence Address: PAUL & PAUL, 2000 MARKET STREET, PHILADELPHIA, PA, 19103-3229, US

(21) Appl. No.: 11/589,561

(22) Filed: Oct. 30, 2006

Related U.S. Application Data
(63) Continuation of application No. PCT/EP05/04202, filed on Apr. 20, 2005.

(30) Foreign Application Priority Data
Apr. 30, 2004 (DE) 10 2004 021 384.4

(51) Int. Cl. C11D 17/00

(52) U.S. Cl. 510/445

(57) ABSTRACT

A method for production of solid granulates with improved storage stability and abrasion resistance, based on the addition of hygroscopic polyols. The solid granulates have improved storage stability and abrasion resistance and are, in particular, enzyme granulates, most particularly, those of admixture components for washing and cleaning agents and washing and cleaning agents comprising said granulates.

### (b) CROSS-REFERENCE TO RELATED APPLICATIONS

This application claims priority under 35 U.S.C. §365(c) and 35 U.S.C. §120 of International Application PCT/EP2005/004202, filed Apr. 20, 2005. This application also claims priority under 35 U.S.C. §119 of German Application No. DE 10 2004 021 384.4, filed Apr. 30, 2004. Both the International Application and the German Application are incorporated herein by reference in their entireties.

### (c) STATEMENT REGARDING FEDERALLY SPONSORED RESEARCH OR DEVELOPMENT

Not Applicable

### (d) INCORPORATION-BY-REFERENCE OF MATERIAL SUBMITTED ON A COMPACT DISC

Not Applicable

### (e) BACKGROUND OF THE INVENTION

(1) Field of the Invention

The present invention relates to a process for producing solid granules with improved storage stability and attrition resistance, especially enzyme granules which are an additive component to washing and/or cleaning compositions, and to washing and/or cleaning compositions which comprise such granules.

Chemical compounds prepared industrially as solids, which are supplied either as finished products or for further processing, are generally in the form of powders, flakes or granules. The granules, in particular, feature good pourability and free flow and a high apparent density.

An example of an important type of further processing consists in mixing the compounds in question mechanically with other compounds with similar formulation. A further step which builds thereon may be the mechanical compaction of such mixtures to macroscopic pieces, as detailed, for example, in the application JP 2004059606 A (cited according to its German-language abstract) for washing and cleaning compositions, perfumes, deodorants, bleaches, fertilizers, water quality improvers and further compositions, according to which the ingredients are additionally mixed with a liquid before the compression.

Owing to the advantages with regard to storage and transport and further processibility, the solids are preferably used in the form of granules in many industrial processes. One example of such processes is the production of washing and cleaning compositions in granulation units, for example, in fluidized beds, mixers, extruders, rollers or in a combination of these units. The products produced, which are produced either as washing composition precursors or additive components or as finished washing and cleaning compositions, advantageously feature relatively high apparent densities in comparison to sprayed products, and also good pouring and flow behavior. In addition, they have the advantage that their particle size distribution is established such that the dust content is only low.

The use of enzymes in solid or in liquid form for various industrial purposes, especially in washing and cleaning compositions, is well established in the prior art. For solid products, the enzymes in question are required in solid and additionally low-water form, for instance as a granule or as a rounded extrudate. In order to protect such particles against adverse external influences, for instance as a result of moisture or aggressive chemical compounds, they can be coated with protective layers. The protective layer thus serves to prevent chemical reactions, which is of crucial importance for the long-term stability, to rule out direct skin contact, to prevent attritus which can access the lungs, to increase the mechanical stability and to establish a controlled-release effect. Moreover, the protective layer can also be used to improve the appearance of the particles, especially the color, but also the odor.

The same technique can also be applied to particles of other washing composition ingredients, especially those which are sensitive toward the other ingredients and/or toward the moisture and can enter into undesired reactions, or which tend to form dust in the case of mechanical stress. For example, allergic reactions are also known against quaternary ammonium compounds.

(2) Description of Related Art, Including Information Disclosed Under 37 C.F.R. §§1.97 and 1.98

Protective layers for particulate washing composition ingredients, especially for enzyme particles, are described in detail in the prior art. These include, for example, those in which the active ingredient as the particle core is surrounded by a simple protective layer. The protective compounds, which are applied, for example, as a solution or as a melt, are, for example, oily or waxlike substances, usually water-soluble polymers, surfactants or polymers formed in situ by condensation polymerization, but also inorganic substances such as silicates (waterglass) or kaolins. It is likewise prior art to incorporate pigments which improve the encapsulating action or the coloring into such protective layers; for this purpose, for example, minerals such as clays or white pigments such as CaCO₃, ZnO or TiO₂ have been described. The waxlike substances, for example, polyethylene glycols (PEGs) or polyvinyl alcohols (PVAs) then additionally fulfill a binder function in comparison to the pigments. Numerous patent applications are concerned with the optimization of the compositions of such coating solutions for the coating of solids.

Multiply coated particles of washing composition ingredients, especially of enzymes, have also already been described in the prior art. For example, according to the application WO 99/32612 A1, the enzyme component need not itself constitute the substantial core of the particle but rather may be applied in the form of a protein-salt mixture as an independent layer to an inert core, the so-called seed particle. The optional binder substance used within the enzyme layer is, for example, starch, modified starch, carrageenan, gum arabic, guar seed flour, polyethylene oxide, polyvinylpyrrolidone or polyethylene glycol. In addition, a second layer composed of compounds such as polyvinyl alcohols (PVAs), polyvinylpyrrolidone, cellulose derivatives, polyethylene glycols (PEGs), polyethylene oxide, chitosan, gum arabic, xanthan and carrageenan may be applied to the enzyme layer in order to coat the seed particle or to externally protect the enzyme-coated particle. This application also discloses corresponding production processes in a fluid bed reactor.

WO 03/055967 A1 discloses an improved process for coating core particles with a salt layer.

WO 92/11347 A2 discloses enzyme granules for use in particulate washing and cleaning compositions which contain from 2% by weight to 20% by weight of enzyme, from 10% by weight to 50% by weight of swellable starch, from 5% by weight to 50% by weight of water-soluble organic polymer as a granulating aid, from 10% by weight to 35% by weight of cereal flour and from 3% by weight to 12% by weight of water. As a result of such additives, enzyme processing without any great activity losses becomes possible.

The patent EP 804532 B1 discloses coated enzyme granules, the enzyme granule itself again having been obtained by coating an inert core, and a coating material which consists of a nonaqueous liquid or an aqueous emulsion thereof or of an ointment-like mixture of such a liquid or emulsion with a component which melts between 30 and 90° C. being applied thereto. The protective layer should comprise an agglomeration-inhibiting agent such as silica fume, calcium phosphate, titanium dioxide, talc or starch, and bring about a low dust count triggered by the particles. According to this patent, the preparation of such particles is possible in any kind of mixer or by spraying the coating materials. Optionally, before the actual coating, one or more preliminary coatings of the enzyme-containing particles can be undertaken, preferably in a fluidized bed reactor.

The patent EP 716685 B1 discloses a process by which an enzyme-containing core optionally comprising support materials and granulating aids is obtained by extrusion, optionally treated in intermediate steps and then coated with a layer of a second enzyme formulated in particulate form beforehand, with or without binder, and the resulting granule is optionally protected externally with a dye- or pigment-containing coating. A larger amount of enzyme should be introduced in the core than in the shell, preferably protease, because it threatens to inactivate the remaining enzymes in the wash liquor.

The application WO 93/07263 A2, which has now been granted in Europe as EP 610321 B1, discloses multiply coated enzyme granules with low dust rate, good stability values and retarded release behavior. These comprise a core of a water-soluble or -dispersible agent, for example, clays, inorganic salts or starches, which can be obtained and coated by various granulation techniques, for example, fluidized bed reactors. Applied thereto, directly or optionally via a vinyl polymer- or vinyl copolymer-containing intermediate layer, is an enzyme layer which likewise contains vinyl polymer or vinyl copolymer; this is concluded externally—optionally via a further intermediate layer which itself comprises a compound which protects the enzyme (especially a chlorine scavenger)—by a layer which likewise comprises a vinyl polymer or vinyl copolymer and optionally pigments and/or binders. Particularly preferred vinyl polymers in each case are polyvinyl alcohols of various molecular weight, various degrees of hydrolysis or viscosities, or mixtures of different polyvinyl alcohols.

WO 00/01793 A1 discloses a coating with a high moisture content. It consists to an extent of at least 60% by weight of a water-soluble substance with a molecular weight of less than 500 g/mol, a certain pH and with a constant moisture content of more than 81% at 20° C. This coating is applied as a solution and the solvent is then distilled off. These water-soluble substances include inorganic salts such as sodium sulfate and sodium citrate. The resulting particles can optionally be coated with further layers, either under the coating with high moisture content or over it.

A physical approach to the description of the desirable properties of granules of active ingredients, for example, enzymes, which are to be protected against mechanical stress is chosen by the application WO 03/000625 A2. It is recommended therein to coat such granules with a flexible polymer film, and this polymer should have a certain biophysical property, specifically a specified maximum elongation value (“elongation upon break”). Examples specified therefor are polymers such as PVA, gelatin or modified starch, optionally with plasticizers, for example, glycerol or propylene glycol, and the possible mixtures should be tested with regard to the maximum elongation value mentioned.

The application US 2004/0033927 A1 discloses granules of core/shell type, whose core matrix, in addition to the active substance, contains from 0.1 to 10% by weight of a synthetic polymer and from 0.2 to 5% by weight of an antioxidant or reducing agent.

An alternative chemical approach is described by WO 2004/058933 A1, according to which a plasticizable substance (“plasticizer”) is applied above its specific glass transition temperature to the granule after its preparation and is drawn into the porous granule to an extent of at least 50%. This affords granules which have been coated (“impregnated”) with the substance in question and have high mechanical stability. However, the disadvantage of this method is that a multitude of substances to be granulated, such as fragrances or enzymes, are destroyed at high temperatures, so that this method is usable only to a restricted extent for these substances.

A further approach to the reduction of the dust count of granules is disclosed by WO 02/078737 A1, according to which an antifoam is added to at least one of the components which are incorporated into granules, especially in a layer-type structure. The antifoam should, in particular, be a copolymer of ethylene oxide and propylene oxide.

The granules known from the prior art and the processes for their production are afflicted with further disadvantages: most of them are either complicated and therefore expensive or bring about, owing to the embrittlement of the granule which occurs in the course of the drying process, an only insufficient mechanical stability and attrition resistance of the granules obtained.

### (f) BRIEF SUMMARY OF THE INVENTION

It is thus an object of the invention to provide an inexpensive process for producing solid granules, which affords mechanically sufficiently stable and attrition-resistant solid granules with low water content.

It has been found that, surprisingly, the mechanical stability and attrition resistance of granules can be increased considerably when the water content of the concentrate to be granulated or the blend of the concentrate with any further additives (premix) is reduced by adding hygroscopic polyols.

Advantageously, as a result of the reduction in the water content brought about in accordance with the invention, less drying of the enzyme granule is required during the extrusion, so that the end product is protected and less energy is consumed. Moreover, as a result of the increased content of meltable and nonaqueous constituents, the core becomes more plastic and hence more easily roundable, which brings about lower attrition and easier coatability.

In comparison with brittle, water-based particles, the inventive granule is additionally more mechanically stable, which leads to lower dust evolution. This is of particular significance especially for enzyme granules which are incorporated into washing and cleaning compositions in large amounts, and increases the product safety considerably, since enzyme dusts, especially those of proteases, can cause allergic reactions of the skin and of the airways.

### (g) BRIEF DESCRIPTION OF THE SEVERAL VIEWS OF THE DRAWING(S)

Not Applicable

### (h) DETAILED DESCRIPTION OF THE INVENTION

The present invention thus provides a process for producing solid granules with improved storage stability and attrition resistance, characterized in that hygroscopic polyols are added.

Solid granules produced in a comparable manner but without addition of hygroscopic polyols are firstly more brittle, so that they release attritus more easily under mechanical stress and have lower enzyme activities after an equal duration of storage. Employing the teaching of the present invention, the addition of hygroscopic polyols thus achieves a higher enzyme stability. Without wishing to be bound to this theory, it can be suspected that this is because oxygen or other harmful compounds can diffuse less easily into the granule particles during the storage and that more particles remain intact as a result of increasing the overall flexibility of the particles. In addition, the formation of dust is also reduced under mechanical stress, which is likewise suspected to be caused by the changed physical properties of the inventive granules.

The hygroscopic polyols to be added in accordance with the invention may be added, for example, to the concentrate to be granulated, for instance to the enzyme concentrate obtained after the enzyme processing, or to the premix, when the concentrate to be formulated is processed further by admixing additives before granulation. This premix is understood to mean the mixture introduced into the actual formulation step (for example, granulation and/or extrusion). It is, for example, the blend of an enzyme concentrate with the starch, cellulose powder or zeolite additives detailed below.

For example, in chapter 6 (“Production of powder detergents” by W. Rähse) of the article “Laundry detergents” in Ullmann's Encyclopedia of Industrial Chemistry (Wiley, VCH, 2005; can be viewed online under: http://www.mrw.interscience.wiley.com/ueic/articles/a08_{—}315/sect6-fs.html; viewed on Apr. 5, 2005), various methods established in the prior art for formulating various chemical compounds, especially for use in washing and cleaning compositions, are described. According to this, the granulation is typically followed by a drying step. If desired (see below), this can be followed by a coating step. According to the invention, all established industrial methods are usable in principle for the granulation of the preparations in question, the selected method also being guided by the physicochemical properties of the substance to be granulated.

A process according to the invention preferably comprises the process step of extrusion.

For example, in the article mentioned (Chapter 6; “Production of Powder detergents” in “Laundry detergents”; Ullmann's Encyclopedia of Industrial Chemistry), a granulation process stated is also the method of extrusion, with which comparatively high densities and intrinsically low-dust products can be achieved.

According to this reference, extrusion can also be applied to the preparation of enzyme formulations. According to the invention, this is particularly advantageous because it can keep the thermal stress on the enzyme preparation low. According to the invention, all known industrial apparatus for extrusion can be used in principle.

Preferred processes according to the invention are characterized in that the hygroscopic polyols are selected from: ethylene glycol, propylene glycol, triethylene glycol, glycerol, monoglycerides, diglycerides, polyethylene glycols (PEGs), polypropylene glycols (PPGs), polyvinyl alcohols (PVAs), polysaccharides, cellulose ethers, alginates, modified starches and hydrolyzates thereof, the polymers and copolymers of these compounds or copolymers thereof with other polymers which are selected from polyethylene oxides, polyvinylpyrrolidones (PVPs) and gelatin, especially selected from: glycerol, cellulose, sorbitol, sucrose and starch.

Among these, preference is given to using those hygroscopic polyols and/or polymers thereof (for example, of PEG or PPG) which are liquid at processing temperature. According to the invention, the hygroscopic polyols can be used individually or in a mixture.

The preparation of the inventive granule particles starts, in the (preferred) case of enzyme granules (see below), preferably from fermentation broths which can be freed from insoluble constituents, for example, by microfiltration. This microfiltration is preferably performed as a crossflow microfiltration using porous tubes with micropores larger than 0.1 μm, flow rates of the concentrate solution of more than 2 m/s and a pressure difference from the permeate side of below 5 bar, as described, for example, in EP 200032 B1. Subsequently, the microfiltration permeate is concentrated down to a desired enzyme content preferably by ultrafiltration, optionally with subsequent vacuum evaporative concentration. The concentration can, as described in WO 92/11347 A2, be conducted so as to arrive only at relatively low contents of dry substance (TS) of preferably from 15% by weight to 50% by weight, in particular, from 20% by weight to 35% by weight.

Processes according to the invention are preferably those which are characterized in that the hygroscopic polyols are used in an amount of from 0.1 to 10% by weight, in particular, from 3 to 7% by weight.

This amount is based on the premix which comprises the active substance actually to be formulated, additives and, in many cases, water; the latter is true especially for the formulation of enzymes which are typically obtained from a workup of aqueous solution. According to the relations of active substance to additive selected for these mixtures (see below), a higher concentration has to be set when the hygroscopic polyols are added not to the premix but actually to the concentrate to be granulated. This process variant is advantageous when—for example, for the modulation of physical properties of the granules—an intimate mixture of the hygroscopic polyol with the active component is to be achieved before admixing of the additives.

It is advantageously possible to add further substances to the concentrate—before it is reacted with the carriers necessary if appropriate, especially sprayed onto them—or to the premix. These further substances characterize the following preferred embodiments:
processes according to the invention which are characterized in that cellulose or cellulose derivative, especially carboxymethylcellulose, is additionally added in a concentration of preferably from 0.1 to 5% by weight, in particular, from 1 to 3% by weight; these are advantageous especially with regard to their contribution to the mechanical stability of the granules (especially as a granulating aid, see below);
processes according to the invention which (if appropriate additionally) are characterized in that monosaccharides, disaccharides and/or oligosaccharides, especially sucrose, are additionally added in a concentration of preferably from 0.1 to 5% by weight, in particular, from 1 to 3% by weight; these are advantageous especially with regard to their contribution to the later dissolution behavior when the granules are used; and
processes according to the invention which (if appropriate additionally) are characterized in that sugar alcohols, especially sorbitol, are additionally added in a concentration of preferably from 0.1 to 5% by weight, in particular, from 1 to 3% by weight; these are advantageous both with regard to their contribution to the mechanical stability of the granules and with regard to their contribution to the later dissolution behavior when the granules are used.

These percentages by weight are based in turn on the premix. When the substances mentioned are added directly to the concentrate to be granulated, these values should be adjusted according to the later dilution by additives mixed in if appropriate.

Further preferred embodiments of the present invention are processes according to the invention which (if appropriate additionally) are characterized in that stabilizers are additionally added in a concentration of preferably from 0.1 to 5% by weight, in particular, from 1 to 4% by weight.

These percentages by weight are based in turn on the premix and should be adjusted appropriately when additives are added.

Stabilizers are in principle understood to mean all chemical compounds which protect a protein and/or enzyme present in an inventive granule particularly during storage against damage, for example, inactivation, denaturation or decomposition, for instance as a result of physical influences, oxidation or proteolytic cleavage. Advantageously, the stabilizer selected are those which lead intrinsically only to low odor nuisance.

One group of stabilizers is that of reversible protease inhibitors. Frequently, benzamidine hydrochloride, borax, boric acids, boronic acids or salts or esters thereof are used for this purpose, in particular, including derivatives with aromatic groups, for instance, ortho-, meta- or para-substituted phenylboronic acids, especially 4-formylphenylboronic acid, or the salts or esters of the compounds mentioned. Peptide aldehydes, i.e. oligopeptides with a reduced C terminus, especially those formed from 2 to 50 monomers, are used for this purpose. The peptidic reversible protease inhibitors include ovomucoid and leupeptin. Specific, reversible peptide inhibitors for the protease subtilisin and fusion proteins formed from proteases and specific peptide inhibitors are also suitable for this purpose.

Further enzyme stabilizers are amino alcohols such as mono-, di-, triethanol- and -propanolamine and mixtures thereof, aliphatic carboxylic acids up to C₁₂, for example, succinic acid, other dicarboxylic acids or salts of the acids mentioned. End group-capped fatty acid amide alkoxylates are also suitable for this purpose. Certain organic acids used as builders are capable, as disclosed in WO 97/18287, of additionally stabilizing an enzyme present.

Lower aliphatic alcohols, but in particular polyols, for example, glycerol, ethylene glycol, propylene glycol or sorbitol, are further frequently used enzyme stabilizers, so that they, when they already serve in accordance with the invention as a hygroscopic polyol for improving the storage stability and attrition resistance, exert a double function. Diglyceryl phosphate too protects against denaturation by virtue of physical influences. Calcium and/or magnesium salts are likewise used, for example, calcium acetate or calcium formate.

Polyamide oligomers or polymeric compounds such as lignin, water-soluble vinyl copolymers or cellulose ethers, acrylic polymers and/or polyamides stabilize the enzyme preparation, inter alia, against physical influences or pH variations. Polyamine N-oxide-containing polymers act simultaneously as enzyme stabilizers and as dye transfer inhibitors. Other polymeric stabilizers are linear C₈-C₁₈ polyoxyalkylenes. Alkylpolyglycosides too can stabilize the enzymatic components of the inventive composition and are capable preferably of additionally enhancing their performance. Crosslinked N-containing compounds likewise fulfill a double function as soil release agents and as enzyme stabilizers. Hydrophobic nonionic polymer stabilizes, in particular, any cellulase present.

Reducing agents and antioxidants increase the stability of the enzymes toward oxidative decomposition; for this purpose, for example, sulfur-containing reducing agents are familiar. Other examples are sodium sulfite and reducing sugars.

Particular preference is given to using combinations of stabilizers, for example, of polyols, boric acid and/or borax, the combination of boric acid or borate, reducing salts and succinic acid or other dicarboxylic acids, or the combination of boric acid or borate with polyols or polyamino compounds and with reducing salts. The action of peptide aldehyde stabilizers is favorably enhanced by the combination with boric acid and/or boric acid derivatives and polyols, and even further by the additional action of divalent cations, for example calcium ions.

The processes are preferably characterized in that the stabilizers are selected from: ascorbic acid, sodium citrate, sodium sulfite, sodium thiosulfate and mixtures thereof. In the case of enzyme granules, in particular, especially their reducing and antioxidant action is required.

As has already become clear from the remarks so far, the granules produced by processes according to the invention may receive different active ingredients.

Preference is given to those processes which are characterized in that organic chemical compounds such as proteins, especially enzymes, polysaccharides or nonbiological polymers, polyethylene glycols, natural or synthetic fats, long-chain fatty acids, long-chain fatty alcohols, biopolymers (for example xanthan), paraffins or long-chain nonionic surfactants are incorporated into the granules (as the ingredients actually to be formulated) indvidually, in a mixture and/or in carrier substances.

These are compounds which are firstly important ingredients of washing and cleaning compositions, in particular, and are secondly advantageously provided in the form of separate granules. This is firstly a result of the production process of these ingredients, which is effected in usually different plants and frequently also at a different place from the actual formulation of the composition in question. On the other hand, they are for the most part chemically reactive and/or sensitive ingredients which are added to the compositions mentioned advantageously as separate components and not in an intimate mixture with other ingredients of the finally produced end products (for example washing or cleaning compositions).

Among these, preference is further given to those processes which are characterized in that enzymes which have been obtained from microorganisms and freed from the cells, such as proteases, lipases, amylases, mannanases and/or cellulases, preferably obtained from Bacillus species or from proteases derived therefrom, are incorporated into the granules alone or in combination with other enzymes.

These are ingredients which are particularly complicated to produce and sensitive for washing and cleaning compositions. They are described in detail below in the description of the granules.

In the particularly preferred embodiments cited here by way of example, an enzyme concentrate is used in an addition amount of from about 15 to 40%, in particular, from 20 to 35%, based on the moist premix to be granulated. The amount of cellulose used if appropriate is advantageously from about 0 to 5%, in particular, from 1 to 3%; the amount of sugar used if appropriate is from about 0 to 5%, in particular, from 1 to 3%, and the amount of stabilizer used if appropriate is from about 0 to 5%, in particular, from 1 to 4%. Suitable stabilizers for the enzyme concentrate are, for example, ascorbic acid, sodium citrate and sodium sulfite. The hygroscopic polyol, especially glycerol, is used preferably in an amount of 0-10%, in particular, of 3-7%.

The viscosity of the concentrate is preferably in the range from 1 to 200 mPas, in particular, from 1 to 25 mPas. The enzyme activity of the concentrate is, when it is a protease granule, preferably from 500,000 to 1,500,000 HPE/g, in particular, from 1,000,000 to 1,300,000 HPE/g, or, when it is an amylase granule, preferably from 25,000 to 75,000 TAU/g, in particular, from 50,000 to 65,000 TAU/g. The protease activity in HPE can be determined according to van Raay, Saran and Verbeek according to the publication “Zur Bestimmung der proteolytischen Aktivität in Enzymkonzentraten und enzymhaltigen Wasch-, Spül- und Reinigungsmitteln” [The determination of the proteolytic activity in enzyme concentrates and enzyme-containing laundry detergents, dishwasher detergents and cleaning compositions] in Tenside (1970), volume 7, p. 125-132. To determine the amylolytic activity in TAU, a modified p-nitrophenylmaltoheptaoside is used, whose terminal glucose unit is blocked by a benzylidene group; this is cleaved by means of amylase to free p-nitrophenyl oligosaccharide which is in turn converted by means of the auxiliary enzymes glucoamylase and alpha-glucosidase to glucose and p-nitrophenol. Hence, the amount of p-nitrophenol released is proportional to the amylase activity. The measurement is effected, for example, with the Quick-Start® test kit from Abbott, Abott Park, Ill., USA. The absorption increase (405 nm) in the test mixture is detected by means of a photometer against a blank value at 37° C. over 3 min. The calibration is effected by means of an enzyme standard of known activity (for example, Maxamyl®/Purastar® 2900 from Genencor, Palo Alto, Calif., USA, with 2900 TAU/g). The evaluation is effected by means of plotting the absorption difference dE (405 nm) per min against the enzyme concentration of the standard.

The enriched concentrate which may have been formed in this way is stirred and then converted to a premix advantageously by spraying it onto a carrier matrix. Useful carrier materials for the enzyme are in principle all organic or inorganic pulverulent substances which destroy or inactivate the enzymes to be granulated only to a tolerably low extent, if at all, and are stable under granulation conditions. Such substances include, for example, starch, cereal flour, cellulose powder, alkali metal aluminosilicate, especially zeolite, sheet silicate, for example, bentonite or smectite, and water-soluble inorganic or organic salts, for example, alkali metal chloride, alkali metal sulfate, alkali metal carbonate, citrate or acetate, sodium or potassium being the preferred alkali metals. Preference is given to using a carrier material mixture which comprises water-swellable starch and if appropriate cereal flour, cellulose powder and/or alkali metal carbonate.

The water-swellable starch is preferably corn starch, wheat starch and rice starch, and also potato starch or mixtures thereof, preference being given to the use of corn starch and wheat starch. Swellable starch is present in the inventive enzyme granules preferably in amounts of from 1% by weight to 50% by weight, in particular, from 1 to 10% by weight, preferably from 3% by weight to 6% by weight.

The cereal flour which may be present is, in particular, a product producible from wheat, rye, barley or oats, or a mixture of these flours, preference being given to wholemeal flours. A wholemeal flour is understood to mean an incompletely milled flour which has been produced from whole, undehusked grains or consists at least predominantly of such a product, the rest consisting of fully ground flour or starch. Preference is given to using commercial wheat flour qualities, such as type 450 or type 550. It is also possible to use flour products of the cereal types leading to aforementioned swellable starches when it is ensured that the flours have been produced from the whole grains. The flour component of the additive mixture is known to achieve a significant odor reduction in the enzyme formulation, which far exceeds the odor reduction as a result of the incorporation of equal amounts of appropriate starch types. Such cereal flour is present in the inventive enzyme granules preferably in amounts up to 45% by weight, in particular, from 10% by weight to 28% by weight.

The inventive enzyme granules receive, as a result of the processes described here, as a further component of the carrier material, preferably from 1% by weight to 50% by weight, in particular, from 5% by weight to 25% by weight, based on the overall granule, of a granulation aid system which comprises alkali metal carboxymethylcellulose with degrees of substitution of from 0.5 to 1 and polyethylene glycol and/or alkyl polyethoxylate. This granulation aid system preferably contains, based in each case on finished enzyme granule, from 0.5% by weight to 5% by weight of alkali metal carboxymethylcellulose with degrees of substitution of from 0.5 to 1 and up to 4% by weight of polyethylene glycol having a mean molar mass of preferably from 400 to 35,000, in particular, from 1,500 to 4,000, and/or alkyl polyethoxylate.

Phosphated, optionally partly hydrolyzed starches are also useful as a granulation aid. Phosphated starch is understood to mean a starch derivative in which hydroxyl groups of the starch anhydroglucose units have been replaced by the —O—P(O)(OH)₂ group or water-soluble salts thereof, especially alkali metal salts such as sodium and/or potassium salts. The mean degree of phosphation of the starch is understood to mean the number of esterified phosphate-bearing oxygen atoms per saccharide monomer of the starch averaged over all saccharide units. The mean degree of phosphation in phosphated starches used with preference is in the range from 1.5 to 2.5, especially since much smaller amounts are required when they are used to achieve a certain granule strength than when carboxymethylcellulose is used. In the context of the present invention, partly hydrolyzed starches shall be understood to mean oligo- or polymers of carbohydrates which are obtainable by customary, for example, acid- or enzyme-catalyzed, processes by partial hydrolysis of starch. They are preferably hydrolysis products having mean molar masses in the range from 440 to 500,000. Preference is given to polysaccharides having a dextrose equivalent (DE) in the range from 0.5 to 40, in particular, from 2 to 30, DE being a common measure for the reducing action of a polysaccharide in comparison to dextrose which has a DE of 100. After phosphation, it is possible to use either maltodextrins (DE from 3 to 20) and dry glucose syrups (DE from 20 to 37), and so-called yellow dextrins and white dextrins having higher mean molar masses in the range from about 2,000 to 30,000. Based on finished granule, preference is given to contents of from 0.1% by weight to 20% by weight, in particular, from 0.5% by weight to 15% by weight, of phosphated starch.

It is also possible if appropriate to use, as additional constituents of the granulation aid system, further cellulose or starch ethers such as carboxymethyl starch, methylcellulose, hydroxyethylcellulose, hydroxypropylcellulose and corresponding cellulose ethers, gelatin, casein, tragacanth, maltodextrose, sucrose, invert sugar, glucose syrup or other oligomers or polymers of natural or synthetic origin which are soluble or readily dispersible in water. Useful synthetic water-soluble polymers are polyacrylates, polymethacrylates, copolymers of acrylic acid with maleic acid or vinyl-containing compounds, and also polyvinyl alcohol, partly hydrolyzed polyvinyl acetate and polyvinylpyrrolidone. When the aforementioned compounds are those having free carboxyl groups, they are normally in the form of their alkali metal salts, especially of their sodium salts. Such additional granulating aids may be present in the inventive enzyme granules in amounts up to 10% by weight, in particular, from 0.5% by weight to 8% by weight.

In a preferred embodiment of the process according to the invention, an enzyme to be incorporated, before it is incorporated into the mixture of the above-described additives, is coated. For this purpose, the aqueous concentrated enzyme solution, before it is introduced into the mixer with the matrix material, is preferably admixed with a substance having surface-active properties, for example, a surfactant (nonionic surfactant or anionic surfactant). The surfactant molecules become ordered within the approx. 10 μm liquid droplets in such a way that the hydrophobic molecular moieties point outward. After drying and customary formulation as described below, particles are then obtained which are coated with an ultrathin surfactant layer and embedded into the matrix. Instead of surfactant, it is also possible to use polymers which have been adjusted hydrophobically, for example, cellulose ethers such as HEC (hydroxyethylcellulose) or starch ethers, or synthetic polymers with similar properties, for example, PVA or end group-capped PEGs (for example, C₁₈ EO; see also the book “Water-soluble polymers” by Yale L. Meltzer, NOYES publishers, 1981, whose disclosure is hereby fully incorporated by reference.

The concentrate is—optionally after coating the enzyme—metered into a dry, pulverulent to particulate mixture, which has appropriately been produced beforehand, of the above-described additives. The water content of the mixture should—taking account of the water content of the concentrate reduced in accordance with the invention—be selected such that it can be converted when processed with stirring and beating tools to particulate particles which do not adhere at room temperature and can be deformed plastically and extruded on application of elevated pressure. The free-flowing premix is then processed in a manner known in principle in a kneader and an attached extruder to give a plastic, very homogeneous mass, in the course of which, as a consequence of the mechanical processing, the mass can heat up to temperatures between 15 and 80° C., in particular, 40 and 60° C., in particular, to from 45° C. to 55° C. According to the invention, an advantageous extrusion temperature is below 50° C. and an advantageous extrusion pressure is in the range from 30 to 130 bar, in particular, in the range from 50 to 90 bar. The material leaving the extruder is conducted through a perforated disk with downstream cutting-off blade and hence comminuted to cylindrical particles of defined size. Appropriately, the diameter of the bores in the perforated disk is from 0.7 mm to 1.2 mm, preferably from 0.8 mm to 1.0 mm.

The generally still-moist particles obtained in this way can then be dried and enveloped to a coating system (see below). It has been found to be advantageous to spheronize the cylindrical particles leaving the extruder and comminuter before they are enveloped, i.e. to round them off and to deburr them in suitable apparatus. For this purpose, an apparatus is used which consists of a cylindrical vessel with stationary, fixed side walls and a friction plate mounted so as to be rotatable at the bottom. Apparatus of this type is widespread in industry under the trademark Marumerizer® and is described, for example, in DE 2137042 and DE 2137043. Subsequently, any dustlike particles which occur with a particle size below 0.1 mm, in particular, below 0.4 mm, and any coarse fractions with a particle size above 2 mm, in particular, above 1.6 mm, can be removed by screening or air sifting and optionally recycled into the production process. After the spheronization, the spheres are dried continuously or batchwise, preferably using a fluidized bed dryer, at air feed temperatures of preferably from 35° C. to 70° C. and, in particular, at a product temperature of not above 42° C., down to the desired residual moisture content of, for example, from 2% by weight to 10% by weight, in particular, from 3% by weight to 8% by weight, based on overall granule, if they have higher water contents beforehand.

This completes the actual inventive production process for solid granules. It can optionally be followed by coating as described below.

Among these, preference is further given to those processes which are characterized in that the enzyme-containing concentrate or premix to be granulated is admixed with a substance having surface-active properties (surfactant).

Provided that the moisture content of the granules obtained thereby remains low, virtually no reaction takes place between these ingredients during the storage. On the other hand, advantageous physical properties can arise especially as a result of these mixtures, especially as far as the achievement of a viscosity favorable for further processing is concerned.

Among these, preference is further given to those processes in which the surfactant is a nonionic, anionic or amphoteric surfactant or a mixture thereof, especially alkoxylated, advantageously ethoxylated, especially primary alcohols having preferably from 8 to 18 carbon atoms and an average of from 1 to 12 mol of ethylene oxide (EO) per mole of alcohol, alkylpolyglycosides (APG), amine oxides, polyhydroxy fatty acid amides, sulfonates, sulfates, fatty acid glycerol esters, alkali metal salts and especially the sodium salts of the sulfuric monoesters of the C₁₂-C₁₈ fatty alcohols, sulfuric monoesters of the straight-chain, branched C₇₋₂₁ alcohols ethoxylated with from 1 to 6 mol of ethylene oxide, saturated fatty acid soaps or mixtures thereof.

These surfactants are usually suitable for blending with enzymes (see above) and, on the other hand, are known in the prior art as particularly advantageous surfactants or surfactant mixtures.

Particularly preferred processes according to the invention are characterized in that the granule particles obtained according to the description so far are coated in a subsequent process step.

Very particular preference is thus given to performing a final, single or multiple coating in a further step which follows the granulation, preferably immediately.

Processes and apparatus for applying single and multiple coatings are known to those skilled in the art and are disclosed by the above-mentioned documents and corresponding textbooks. Among these, mention should be made particularly of the books “Wirbelschicht-Sprühgranulation” [Fluidized bed spray granulation] by H. Uhlemann and L. Mörl, Springer-Verlag, Berlin, Heidelberg, New York, 2000, and “Agglomeration Processes. Phenomena, Technologies, Equipment” by W. Pietsch, Wiley-VHC publishers, Weinheim, 2002.

For this purpose, for example, a sphere coater (turbojet) can be used. In this context, the thesis by Karin Wöstheinrich “Einsatzmöglichkeiten des Hüttlin-Kugelcoaters HKC 05-TJ unter Einbeziehung von Simulationen” [Possible uses of the Hüttlin HKC 05-TJ sphere coater including simulations] is of interest, which can be viewed as an online thesis under the URL http://w210.ub.uni-tuebingen.de/dbt/volltexte/2000/134/index.html (accessed on Apr. 5, 2005).

In a suitable coating process, the granule particles, preferably enzyme particles, are introduced in the hot air stream and the coating material is sprayed by means of a top sprayer. This is effective under drying conditions, i.e. 40-45° C., so that the product is at approx. 35-38° C. and remains dry.

Preferred processes of this type are characterized in that the granule particles, especially enzyme granule particles, are coated with an aqueous emulsion based on silicone oil.

Such a procedure is described, for example, in DE 10108459 A1, according to which granules can be contacted with an aqueous foam regulator suspension which contains from 16 to 70% by weight of an active foam regulator ingredient based, for example, on silicone oil. This procedure has been found to be useful for enzyme granules, in particular.

Processes of this type which are no less preferred are characterized in that the granule particles, especially enzyme granule particles, are coated with a polymer solution comprising an inorganic pigment.

These are preferably processes with the polymer component PEG, PVA, PVP, starch, starch derivative, cellulose, cellulose derivative or mixtures thereof or copolymers thereof, and kaolin, TiO₂ and/or antioxidants as the inorganic pigment.

This procedure too has been found to be useful for enzyme granules, in particular. The teaching of DE 10108459 A1 is applicable to this embodiment too, according to which the active foam regulator ingredient applied may also be based on paraffin wax.

In this context, it may be advantageous to use the polymer in the form of an aqueous solution, for example, as an aqueous PEG solution. Optionally, it is also possible to use surfactant, for example, nonionic surfactant with approx. 80 EO, for the coating.

The following coating processes are particularly preferred:
(1.) a pigment-containing coating composed of: (a) from 5 to 70% by weight (based on the coating) of fine, inorganic, water-insoluble pigment, (b) from 45 to 90% by weight of an organic substance having a melting point of from 40 to 70° C. and (c) up to 20% by weight of a pourability-improving agent is applied; such a coating is disclosed by EP 944704 B1;
(2.) a coating comprising a polyvalent metal salt of an unbranched or branched, unsaturated or saturated, mono- or polyhydroxylated fatty acid having at least 12 carbon atoms is applied; such a coating is disclosed by WO 03/020868 A1;
(3.) a mixture of TiO2, urea and polyethylene glycol having a water content of less than 50% by weight is applied; such a coating is described in the application DE102004062326.0 which had not been published at the priority date of the present application.
(4.) Finally, the possibility exists for the above-specified emulsions based on silicone oil to apply them in the form of water-in-oil emulsions (W/O), oil-in-water emulsions (O/W), multiple emulsions (W/O/W) and nano- and microemulsions.

The present invention further provides solid, coated or uncoated granules of improved storage stability and attrition resistance which are obtainable by the above-described processes according to the invention.

In its most general form, the granule in each case is a solid granule with improved storage stability and attrition resistance, which is characterized in that the granule particles comprise hygroscopic polyols.

In accordance with the process described above, these hygroscopic polyols are to be found in accordance with the invention especially in the matrix, since they are obtained by mixing with the active substance concentrate to be formulated or by incorporation into the premix to be granulated. According to this, the majority of the hygroscopic polyols added in the inventive granules too should remain in the matrix and, if any, only a small fraction should diffuse into the (optional) protective layer. The same applies analogously to the further optional components which are added to the concentrate or the premix to be granulated (see below).

In accordance with the statements made above, preference is given to the following embodiments of this subject matter:
a granule of this type which, with regard to its matrix, is simultaneously an extrudate, i.e. has originally been obtained by extrusion and has the substance properties attributable thereto (see above);
a granule of this type which may additionally be characterized in that the hygroscopic polyols are selected from: ethylene glycol, propylene glycol, triethylene glycol, glycerol, monoglycerides, diglycerides, polyethylene glycols (PEGs), polypropylene glycols (PPGs), polyvinyl alcohols (PVAs), polysaccharides, cellulose ethers, alginates, modified starches and hydrolyzates thereof, the polymers and copolymers of these compounds or copolymers thereof with other polymers which are selected from polyethylene oxides, polyvinylpyrrolidones (PVPs) and gelatin, especially selected from: glycerol, cellulose, sorbitol, sucrose and starch;
a granule of this type which may additionally be characterized in that it comprises, especially in the matrix, stabilizers, especially ascorbic acid, sodium citrate, sodium sulfite, sodium thiosulfate or mixtures thereof;
a granule of this type which may additionally be characterized in that it comprises, especially in the matrix, as the active substances actually to be formulated, organic chemical compounds such as proteins, especially enzymes, polysaccharides or nonbiological polymers, polyethylene glycols, natural or synthetic fats, long-chain fatty acids, long-chain fatty alcohols, biopolymers (for example, xanthan), paraffins or long-chain nonionic surfactants incorporated individually, in a mixture and/or in carrier substances;
a granule of this type which may additionally be characterized in that it comprises, especially in the matrix, enzymes which have been obtained from microorganisms and freed from the cells, such as proteases, lipases, amylases, mannanases and/or cellulases, preferably obtained from Bacillus species or from such derived proteases, are incorporated alone or in combination with other enzymes;
a granule of this type which may additionally be characterized in that it comprises, especially in the matrix, enzymes admixed with a substance having surface-active properties (surfactant);
among these, preference is given in turn to those granules in which the surfactant is a nonionic, anionic or amphoteric surfactant or a mixture thereof, especially alkoxylated, advantageously ethoxylated, especially primary alcohols having preferably from 8 to 18 carbon atoms and an average of from 1 to 12 mol of ethylene oxide (EO) per mole of alcohol, alkylpolyglycosides (APG), amine oxides, polyhydroxy fatty acid amides, sulfonates, sulfates, fatty acid glycerol esters, alkali metal salts and especially the sodium salts of the sulfuric monoesters of the C₁₂-C₁₈ fatty alcohols, sulfuric monoesters of the straight-chain, branched C₇₋₂₁ alcohols ethoxylated with from 1 to 6 mol of ethylene oxide, saturated fatty acid soaps or mixtures thereof;
an inventive granule which may, in addition to the features detailed so far, additionally be characterized in that the granule particles are coated;
among these, preference is given to those granules which are characterized in that the granule particles, especially enzyme granule particles, are coated with an aqueous emulsion based on silicone oil;
among these, no less preferred are also those granules which are characterized in that the granule particles, especially enzyme granule particles, are coated with a layer comprising inorganic pigment and polymer;
among these pigment/polymer-coated granules, preference is given to those which comprise PEG, PVA, PVP, starch, starch derivative, cellulose, cellulose derivative or mixtures thereof or copolymers thereof as the polymer, and kaolin, TiO₂ and/or antioxidants as the inorganic pigment;
further preferred embodiments are the following inventive granules:
(1.) those having a pigment-containing coating composed of: (a) from 5 to 70% by weight (based on the coating) of fine, inorganic, water-insoluble pigment, (b) from 45 to 90% by weight of an organic substance having a melting point of from 40 to 70° C. and (c) up to 20% by weight of a pourability-improving agent,
(2.) those having a coating comprising a polyvalent metal salt of an unbranched or branched, unsaturated or saturated, mono- or polyhydroxylated fatty acid having at least 12 carbon atoms,
(3.) those having a coating comprising a mixture of TiO2, urea and polyethylene glycol having a water content of less than 50% by weight, or
(4.) those having a coating comprising an emulsion which is selected from: water-in-oil emulsions (W/O), oil-in-water emulsions (O/W), multiple emulsions (W/O/W) and nano- and microemulsions.

According to the invention, the granules comprise organic chemical compounds such as proteins, especially enzymes, polysaccharides or nonbiological polymers, polyethylene glycols, natural or synthetic fats, long-chain fatty acids, long-chain fatty alcohols, biopolymers (for example, xanthan), paraffins or long-chain nonionic surfactants which are incorporated into the granules individually, in a mixture and/or in carrier substances. In the context of this invention, long-chain compounds are those compounds which, owing to the alkyl radical, have a softening point above 20° C., preferably even above 25° C.

Useful enzymes are in principle all enzymes established in the prior art, but it is necessary in each case to adjust to the field of use intended for the granules in question. Thus, in connection with the present invention, adjustment is made, in particular, to those enzymes which can be added to washing and/or cleaning compositions owing to their particular contribution to the enhancement of the washing or cleaning performance. Specifically here, it is an object of the invention to provide more storage-stable and attrition-resistant granules.

These include, in particular, proteases, amylases, lipases, hemicellulases, cellulases or oxidoreductases, and preferably mixtures thereof. These enzymes are in principle of natural origin; starting from the natural molecules, improved variants are available for use in washing and cleaning compositions and are preferably used correspondingly.

Among the proteases, preference is given to those of the subtilisin type. Examples thereof include the subtilisins BPN′ and Carlsberg, protease PB92, the subtilisins 147 and 309, Bacillus lentus alkaline protease, subtilisin DY and the enzymes thermitase and proteinase K which can be classified to the subtilases but no longer to the subtilisins in the narrower sense, and the proteases TW3 and TW7. The subtilisin Carlsberg is available in a developed form under the trade name Alcalase® from Novozymes A/S, Bagsvaerd, Denmark. The subtilisins 147 and 309 are sold under the trade names Esperase® and Savinase® respectively by Novozymes. The variants listed under the name BLAP® are derived from the protease of Bacillus lentus DSM 5483 (WO 91/02792 A1), which are described, in particular, in WO 92/21760 A1, WO 95/23221 A1, WO 02/088340 A2 and WO 03/038082 A2. Further useful proteases from different Bacillus sp. and B. gibsonli are disclosed by the patent applications WO 03/054185 A1, WO 03/056017 A2, WO 03/055974 A2 and WO 03/054184 A1.

Further examples of useful proteases are the enzymes available under the trade names Durazym®, Relase®, Everlase®, Nafizym®, Natalase®, Kannase® and Ovozymes® from Novozymes, those under the trade names Purafect®, Purafect® OxP and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan and that under the name Proteinase K-16 from Kao Corp., Tokyo, Japan.

Examples of amylases which can be used in accordance with the invention are the α-amylases from Bacillus licheniformis, from B. amyloliquefaciens or from B. stearothermophilus and developments thereof which have been improved for use in washing and cleaning compositions. The B. licheniformis enzyme is available from Novozymes under the name Termamyl® and from Genencor under the name Purastar® ST. Development products of this α-amylase are obtainable from Novozymes under the trade names Duramyl® and Termamyl® ultra, from Genencor under the name Purastar® OxAm and from Daiwa Seiko Inc., Tokyo, Japan as Keistase®. The B. amyloliquefaciens α-amylase is sold by Novozymes under the name BAN®, and variants derived from the B. stearothermophilus α-amylase under the names BSG® and Novamyl®, likewise from Novozymes.

Enzymes which should additionally be emphasized for this purpose are the α-amylase from Bacillus sp. A 7-7 (DSM 12368) which is disclosed in the application WO 02/10356 A2, and the cyclodextrin glucanotransferase (CGTase) from B. agaradherens (DSM 9948) which is described in the application WO 02/44350 A2. It is also possible to use the amylolytic enzymes which belong to the sequence region of α-amylases which is defined in the application WO 03/002711 A2, and those which are described in the application WO 03/054177 A2. It is equally possible to use fusion products of the molecules mentioned, for example, those from the application DE 10138753 A1.

Also suitable are the developments of α-amylase from Aspergillus niger and A. oryzae, which are available under the trade name Fungamyl® from Novozymes. Further useful commercial products are, for example, Amylase-LT® and Stainzyme®, the latter likewise from Novozymes.

Inventive granules may comprise lipases or cutinases, especially owing to their triglyceride-cleaving activities, but also in order to obtain peracids in situ from suitable precursors. Examples thereof include the lipases which were originally obtainable from Humicola lanuginosa (Thermomyces lanuginosus) or have been developed, in particular, those with the D96L amino acid substitution. They are sold, for example, under the trade names Lipolase®, Lipolase® Ultra, LipoPrime®, Lipozyme® and Lipex® by Novozymes. It is additionally possible, for example, to use the cutinases which have originally been isolated from Fusarium solani pisi and Humicola insolens. Lipases which are also useful can be obtained under the designations Lipase CE®, Lipase P®, Lipase B®, Lipase CES®, Lipase AKG®, Bacillis sp. Lipase®, Lipase AP®, Lipase M-AP® and Lipase AML® from Amano. Examples of lipases and cutinases from Genencor which can be used are those whose starting enzymes have originally been isolated from Pseudomonas mendocina and Fusarium solanji. Other important commercial products which should be mentioned include the M1 Lipase® and Lipomax® preparations originally sold by Gist-Brocades and the enzymes sold under the names Lipase MY-30®, Lipase OF® and Lipase PL® by Meito Sangyo KK, Japan, and also the product Lumafast® from Genencor.

Inventive granules may, especially when they are intended for the treatment of textiles, comprise cellulases, depending on the purpose as pure enzymes, as enzyme preparations or in the form of mixtures in which the individual components advantageously complement one another with respect to their different performance aspects. These performance aspects include, in particular, contributions to the primary washing performance, to the secondary washing performance of the composition (antiredeposition action or graying inhibition) and softening (fabric action), up to exerting a “stone-wash” effect.

A useful fungal, endoglucanase(EG)-rich cellulase preparation and developments thereof are supplied under the trade name Celluzyme® from Novozymes. The products Endolase® and Carezyme®, likewise available from Novozymes, are based on the H. insolens DSM 1800 50 kD EG and 43 kD EG respectively. Further usable commercial products of this company are Cellusoft® and Renozyme®. The latter is based on the application WO 96/29397 A1. Performance-enhancing cellulase derivatives are disclosed, for example, by the application WO 98/12307 A1. Likewise useful are the cellulases disclosed in the application WO 97/14804 A1; for example, the Melanocarpus 20 kD EG cellulase, which is available under the trade names Ecostone® and Biotouch® from AB Enzymes, Finland. Further commercial products from AB Enzymes are Econase® and Ecopulp®. Further suitable cellulases from Bacillus sp. CBS 670.93 and CBS 669.93 are disclosed in WO 96/34092 A2, and that from Bacillus sp. CBS 670.93 is available under the trade name Puradax® from Genencor. Other commercial products from Genencor are Genencor detergent cellulase L and IndiAge® Neutra.

Inventive granules for use in washing and cleaning compositions may, especially to remove particular problem stains, comprise further enzymes which are combined under the term hemicellulases. These include, for example, mannanases, xanthan lyases, pectin lyases (=pectinases), pectin esterases, pectate lyases, xyloglucanases (=xylanases), pullulanases and β-glucanases. Suitable mannanases are available, for example, under the names Gamanase® and Pektinex AR® from Novozymes, under the name Rohapec® B1L from AB Enzymes, under the name Pyrolase® from Diversa Corp., San Diego, Calif., USA and under the name Purabrite® from Genencor Int., Inc., Palo Alto, Calif., USA. A suitable β-glucanase from a B. alcalophilus is disclosed, for example, by the application WO 99/06573 A1. The β-glucanase obtained from B. subtilis is available under the name Cereflo® from Novozymes.

To enhance the bleaching action, inventive granules, especially for washing and cleaning compositions, may comprise oxidoreductases, for example, oxidases, oxygenases, catalases, peroxidases, such as haloperoxidases, chloroperoxidases, bromoperoxidases, lignin peroxidases, glucose peroxidases or manganese peroxidases, dioxygenases or laccases (phenol oxidases, polyphenol oxidases). Suitable commercial products include Denilite® 1 and 2 from Novozymes. Advantageously, preferably organic, more preferably aromatic, compounds which interact with the enzymes are additionally added in order to enhance the activity of the oxidoreductases concerned (enhancers), or to ensure the electron flux in the event of large differences in the redox potentials of the oxidizing enzymes and the soilings (mediators).

The enzymes used in the inventive granules derive, for example, either originally from microorganisms, for example, of the genera Bacillus, Streptomyces, Humicola, or Pseudomonas, and/or are produced in biotechnology processes known per se by suitable microorganisms, for instance by transgenic expression hosts of the genera Bacillus or filamentous fungi.

The enzymes in question are favorably purified via processes which are established per se, for example, via precipitation, sedimentation, concentration, filtration of the liquid phases, microfiltration, ultrafiltration, the action of chemicals, deodorization or suitable combinations of these steps.

It is also possible to formulate two or more enzymes together, so that an individual granule has a plurality of enzyme activities.

Enzymes are present in the inventive granules preferably in amounts of from 4% by weight to 20% by weight. When the inventive enzyme granule is a protease-containing formulation, the protease activity is preferably from 150,000 to 550,000 HPE (see above), in particular, from 160,000 to 300,000 HPE per gram of enzyme granule. In an amylase formulation, the amylase activity is preferably from 7,500 to 27,500 TAU (see above), in particular, from 8,000 to 15,000 TAU per gram of enzyme granule.

The resulting granule particles, preferably enzyme particles, have an average size of 0.85 mm. The outer layer is advantageously from approx. 7 to 30 μm thick.

The granule obtained by the process according to the invention consists of largely rounded, uniformly enveloped and dust-free particles which generally have an apparent density of from about 500 to 800 grams per liter, in particular, from 600 to 720 grams per liter. The inventive granules are notable for very high storage stability, especially at temperatures above room temperature and high air humidity, and also rapid and virtually complete dissolution behavior in water. The inventive granules preferably release 100% of their enzyme activity within 3 minutes, in particular, within from 90 seconds to 2 minutes, in water at 25° C.

Depending on the field of use of the ingredients, the granules described here can be added appropriately to suitable compositions. In this context, in accordance with the invention, washing and cleaning compositions are at the forefront.

The invention thus further provides washing and/or cleaning compositions which comprise the above-described inventive granules.

This subject of the invention includes all conceivable cleaning composition types, both concentrates and compositions to be used undiluted, for use on the commercial scale, in a washing machine or in hand washing or cleaning. These include, for example, washing compositions for textiles, carpets or natural fibers, for which the term washing compositions is used according to the present invention. They also include, for example, dishwashing detergents for machine dishwashers or manual dishwashing detergents or detergents for hard surfaces such as metal, glass, porcelain, ceramic, tiles, stone, varnished surfaces, plastics, wood or leather; for such compositions, the term cleaning compositions is used according to the present invention.

Embodiments of the present invention include all appropriate supply forms of the inventive washing or cleaning compositions and/or all of those which have become established according to the prior art. These include, in particular, solid, pulverulent compositions, if appropriate also consisting of a plurality of phases, compressed or uncompressed; these include, for example: extrudates, granules, tablets or pouches, either in large containers or packaged in portions.

In addition to granules, preferably of enzymes, an inventive washing or cleaning composition optionally comprises further ingredients such as enzyme stabilizers (see above), surfactants, for example, nonionic, anionic and/or amphoteric surfactants, and/or bleaches, and/or builders, and if appropriate further customary ingredients among which mention should be made, in particular, of the following: (other) enzymes, especially those already listed above, sequestrants, electrolytes, optical brighteners, graying inhibitors, silver corrosion inhibitors, dye transfer inhibitors, foam inhibitors, abrasives, dyes and/or fragrances, and active microbial ingredients and/or UV absorbents.

For the production and composition of washing and/or cleaning compositions, there is comprehensive prior art, to which reference is made here. Typically, the compositions are tailored to specific problems as far as, for example, the stains, use temperatures and media or application means are concerned. The inventive granules are included in such optimizations, for example, with regard to their dissolution performance or balancing of the components present.

In accordance with the remarks so far, the use of the inventive granules described as an additive component in washing or cleaning compositions forms a further part of the subject matter of the present invention.

The inventive enzyme granule or that prepared by the process according to the invention is preferably used to produce solid, especially particulate, washing or cleaning compositions which can be obtained by simply mixing the enzyme granules with further powder components typical in such compositions. For processing into particulate washing and cleaning compositions, the enzyme granule preferably has mean particle sizes in the range from 0.7 to 1.2 mm. The inventive granules comprise preferably less than 2% by weight, in particular, at most 1.4% by weight, of particles having particle sizes outside the range from 0.4 to 1.6 mm. The process is, though, not restricted to these particle sizes but rather covers a broad particle size spectrum corresponding to the field of use; typically, the average particle diameter (d₅₀) is between 0.1 to more than 2 mm.

The example which follows illustrates the invention but without restricting it thereto.

### EXAMPLES

### EXAMPLE

Starting Material:

Protease concentrate with 1,130,00 HPE/g and 32.5% dry substance (TS).

Premix for Extrusion:

Enzyme concentrate 23%, stabilizer 1%, glycerol 5%, cellulose 1%, sugar 1%, swollen wheat starch 4%, wheat flour 25%, PEG 4,000 3%, corn starch 37% are mixed in a Lödige mixer for 90 s.

Extrusion at approx. 50° C. and 90 bar in a twin-shaft extruder with cutting apparatus, particle size 0.85 mm.

Subsequent rounding of the particles within 90 s.

Drying of the particles in a fluidized bed dryer at 35° C. to water content 6%; coating of enzyme granule with aqueous suspension (TiO₂, PEG, water) and subsequent drying.

Determination of the Specification Parameters:

Dust value (by IBIS test): 4 mg

L-test (90 s): <1%

Activity of the granule: 260,000 HPE/g (adjusted)

Apparent density: 620 g/l.

### (k) SEQUENCE LISTING

Not Applicable

1. A process for producing solid granules with improved storage stability and attrition resistance, said process comprising the process step of extrusion, characterized in that hygroscopic polyols are added in an amount of 0.1-7% by weight.

2. The process as claimed in claim 1, characterized in that the hygroscopic polyols are selected from the group consisting of ethylene glycol, propylene glycol, triethylene glycol, glycerol, monoglycerides, diglycerides, polyethylene glycols, polypropylene glycols, polyvinyl alcohols, polysaccharides, cellulose ethers, alginates, modified starches and hydrolyzates thereof, the polymers and copolymers of these compounds or copolymers thereof with other polymers which are selected from polyethylene oxides, polyvinylpyrrolidones, gelatin, glycerol, cellulose, sorbitol, sucrose and starch.

3. The process as claimed in claim 1, characterized in that the hygroscopic polyols are present in the composition in an amount of from 3 to 7% by weight.

4. The process as claimed in claim 1, characterized in that a cellulose or cellulose derivative is added to the composition in a concentration of from 0.1 to 5% by weight of the composition.

5. The process as claimed in claim 1, characterized in that at least one of the monosaccharides, disaccharides, oligosaccharides, and sucrose, are added to the composition in a concentration of from 0.1 to 5% by weight of the composition.

6. The process as claimed in claim 1, characterized in that at least one of the sugar alcohols, and sorbitol, are added to the composition in a concentration of from 0.1 to 5% by weight of the composition.

7. The process as claimed in claim 1, characterized in that at least one stabilizer is added to the composition in a concentration of from 0.1 to 5% by weight of the composition.

8. The process as claimed in claim 7, characterized in that the stabilizers are selected from the group consisting of ascorbic acid, sodium citrate, sodium sulfite, sodium thiosulfate and mixtures thereof.

9. The process as claimed in claim 1, characterized in that organic chemical compounds selected from the group consisting of proteins, enzymes, polysaccharides, nonbiological polymers, polyethylene glycols, natural or synthetic fats, long-chain fatty acids, long-chain fatty alcohols, biopolymers, paraffins and long-chain nonionic surfactants are incorporated into the granules.

10. The process as claimed in claim 9, characterized in that the enzymes comprise at least one of proteases, lipases, amylases, mannanases and cellulases.

11. The process as claimed in claim 9, characterized in that the enzyme-containing concentrate or premix to be granulated is admixed with a substance having surface-active properties.

12. The process as claimed in claim 11, in which the substances having surface-active properties is selected from the group consisting of nonionic, anionic and amphoteric surfactants and mixtures thereof, alkoxylated alcohols, ethoxylated alcohols, primary alcohols having from 8 to 18 carbon atoms and an average of from 1 to 12 mol of ethylene oxide per mole of alcohol, alkylpolyglycosides, amine oxides, polyhydroxy fatty acid amides, sulfonates, sulfates, fatty acid glycerol esters, alkali metal salts of the sulfuric monoesters of the C₁₂-C₁₈ fatty alcohols, the sodium salts of the sulfuric monoesters of the C₁₂-C₁₈ fatty alcohols, sulfuric monoesters of the straight-chain, branched C₇₋₂₁ alcohols ethoxylated with from 1 to 6 mol of ethylene oxide, saturated fatty acid soaps and mixtures thereof.

13. The process as claimed in claim 1, comprising the additional step of coating the granule particles.

14. The process as claimed in claim 13, characterized in that the granule particles are coated with an aqueous emulsion based on silicone oil.

15. The process as claimed in claim 13, characterized in that the granule particles are coated with a polymer solution comprising an inorganic pigment.

16. The process as claimed in claim 15, with polyethylene glycol, polyvinyl alcohol, polyvinylpyrollidone, starch, starch derivative, cellulose, cellulose derivative or mixtures thereof or copolymers thereof as the polymer, and kaolin, TiO₂ and/or antioxidants as the inorganic pigment.

17. The process as claimed in claim 13, comprising at least one of the following coating steps:
(1.) a pigment-containing coating composed of: (a) from 5 to 70% by weight (based on the coating) of fine, inorganic, water-insoluble pigment, (b) from 45 to 90% by weight of an organic substance having a melting point of from 40 to 70° C. and (c) up to 20% by weight of a pourability-improving agent is applied,
(2.) a coating comprising a polyvalent metal salt of an unbranched or branched, unsaturated or saturated, mono- or polyhydroxylated fatty acid having at least 12 carbon atoms is applied,
(3.) a mixture of TiO₂, urea and polyethylene glycol having a water content of less than 50% by weight is applied, and
(4.) an emulsion is applied which is selected from: water-in-oil emulsions, oil-in-water emulsions, multiple emulsions and nano- and microemulsions.

18. A solid granule having improved storage stability and attrition resistance, the matrix of which is simultaneously an extrudate, characterized in that the granule particles comprise hygroscopic polyols in an amount of 0.1-7% by weight.

19. The granule as claimed in claim 18, characterized in that the hygroscopic polyols are selected from the group consisting of ethylene glycol, propylene glycol, triethylene glycol, glycerol, monoglycerides, diglycerides, polyethylene glycols, polypropylene glycols, polyvinyl alcohols, polysaccharides, cellulose ethers, alginates, modified starches and hydrolyzates thereof, the polymers and copolymers of these compounds or copolymers thereof with other polymers which are selected from polyethylene oxides, polyvinylpyrrolidones, gelatin, glycerol, cellulose, sorbitol, sucrose and starch.

20. The granule as claimed in claim 18 characterized in that the granule comprises at least one of stabilizers, ascorbic acid, sodium citrate, sodium sulfite, sodium thiosulfate or mixtures thereof.

21. The granule as claimed in claim 18, characterized in that the granule further comprises organic chemical compounds selected from the group consisting of proteins, enzymes, polysaccharides or nonbiological polymers, polyethylene glycols, natural or synthetic fats, long-chain fatty acids, long-chain fatty alcohols, biopolymers, xanthan, paraffins and long-chain nonionic surfactants.

22. The granule as claimed in claim 21, characterized in that it comprises enzymes comprising at least one of proteases, lipases, amylases, mannanases and cellulases.

23. The granule as claimed in claim 18, characterized in that it comprises enzymes admixed with a substance having surface-active properties.

24. The granule as claimed in claim 23, in which the substance having surface-active properties is selected from the group consisting of nonionic, anionic and amphoteric surfactants and mixtures thereof, alkoxylated alcohols, ethoxylated alcohols, primary alcohols having preferably from 8 to 18 carbon atoms and an average of from 1 to 12 mol of ethylene oxide per mole of alcohol, alkylpolyglycosides, amine oxides, polyhydroxy fatty acid amides, sulfonates, sulfates, fatty acid glycerol esters, alkali metal salts of the sulfuric monoesters of the C₁₂-C₁₈ fatty alcohols, sodium salts of the sulfuric monoesters of the C₁₂₋C₁₈ fatty alcohols, sulfuric monoesters of the straight-chain, branched C₇₋₂₁ alcohols ethoxylated with from 1 to 6 mol of ethylene oxide, saturated fatty acid soaps and mixtures thereof.

25. The granule as claimed in claim 18, characterized in that the granule particles are coated.

26. The granule as claimed in claim 25, characterized in that the granule particles are coated with an aqueous emulsion based on silicone oil.

27. The granule as claimed in claim 25, characterized in that the granule particles are coated with a layer comprising inorganic pigment and polymer.

28. The granule as claimed in claim 27, wherein the polymer is selected from the group consisting of polyethylene glycol, polyvinylalcohol, polyvinylpyrollidone, starch, starch derivative, cellulose, cellulose derivative and copolymers and mixtures thereof, and kaolin, TiO₂ and/or antioxidants as the inorganic pigment.

29. The granule as claimed in claim 25, comprising as a coating at least one of:
(1.) a pigment-containing coating composed of: (a) from 5 to 70% by weight (based on the coating) of fine, inorganic, water-insoluble pigment, (b) from 45 to 90% by weight of an organic substance having a melting point of from 40 to 70° C. and (c) up to 20% by weight of a pourability-improving agent;
(2.) a coating comprising a polyvalent metal salt of an unbranched or branched, unsaturated or saturated, mono- or polyhydroxylated fatty acid having at least 12 carbon atoms;
(3.) a mixture of TiO₂, urea and polyethylene glycol having a water content of less than 50% by weight; and
(4.) a coating comprising an emulsion which is selected from: water-in-oil emulsions, oil-in-water emulsions, multiple emulsions and nano- and microemulsions.

30. A washing or cleaning composition comprising a solid granule having improved storage stability and attrition resistance, the matrix of which is simultaneously an extrudate, characterized in that the granule particles comprise hygroscopic polyols in an amount of 0.1-7% by weight.

31. A washing or cleaning process comprising the step of contacting the article to be washed or cleaned with the washing or cleaning composition of claim 30.
